(19) United States
(12) Patent Application Publication
(10) Pub. No.: US 2006/0280872 A1
(43) Pub. Date: Dec. 14, 2006

(54) METHOD FOR DIRECT METALLIZATION OF NON-CONDUCTING SUBSTRATES

(75) Inventors: Andreas Konigshofen, Leverkusen (DE); Andreas Mobius, Kaarst (DE)

Correspondence Address: SENNIGER POWERS, ONE METROPOLITAN SQUARE, 16TH FLOOR, ST LOUIS, MO, 63102, US

(73) Assignee: ENTHONE INC., West Haven, CT (US)

(21) Appl. No.: 11/423,474

(22) Filed: Jun. 12, 2006

(30) Foreign Application Priority Data
Jun. 10, 2005 (DE) 10 2005 027 123.5

(51) Int. Cl. B05D 3/00

(52) U.S. Cl. 427/299

(57) ABSTRACT

In the plating of non-conductive substrates, a metal-salt solution for treatment of such a substrate having been treated with a metal colloid for activation, and associated method for coating non-conductive substrates, characterized by reduced incrustation the associated equipment; the metal-salt solution comprising a metal that can be reduced by the metal of the metal colloid, a complexing agent, and a metal salt having a metal of the group consisting of lithium, sodium, calcium, rubidium, and cesium in the form of a salt selected from the group consisting of fluorides, chlorides, iodides, bromides, nitrates, sulphates, and mixtures thereof.

### CROSS REFERENCE TO RELATED APPLICATIONS

This application claims priority from DE patent application number 10 2005 027 123.5 filed Jun. 10, 2005, the entire disclosure of which is herein incorporated by reference.

### FIELD OF THE INVENTION

The present invention relates to a method for the direct metallization of non-conducting substrates.

### BACKGROUND OF THE INVENTION

Different methods for the direct metallization of non-conducting substrates, such as for example boards for printed circuit boards or plastic mouldings, are known from the state of the art.

Thus, the European Patent Application EP 0 538 006 discloses a method for direct metallization, in which the substrate is activated with an activator solution comprising a palladium tin colloid and after the activation it is brought into contact with a post-activator solution which contains a sufficient quantity of ions undergoing a disproportionation reaction under the given reaction conditions. The thus treated substrate is subsequently treated with an acid solution.

The European Patent EP 0 616 053 discloses an identical method, wherein however the metal composition contains the metal to be deposited in form of the highest oxidation state.

The methods known from the state of the art have in common that the use thereof in big technical scale leads to problems such as incrustations due to salt deposits on the installation components. This leads to insufficient coating results, such that the installations that are operated according to the state of the art have to be purified and liberated from incrustations in regular intervals.

In methods known from the state of art, after a few hours, there is a precipitation of low solubility of lithiumcarbonate on heating elements and walls of a tank, because black-damp in the air gets in a alkaline solution and there subsequently is dissolved to carbonate. The precipitations of lithiumcarbonate have a bad influence on the flow of the process, because off flaking small particles lead to roughness and therefore to higher rates of waste, and through incrustation of heating elements the heating power is that much reduced, that on one hand the power of current consumption is increased, an on the other hand it is only possible to hold the operating temperature through additional heating elements.

### SUMMARY OF THE INVENTION

It is the object of the invention to provide an improved method for direct metallization, which is able to overcome the problems known from the state of the art, in particular the problems due to incrustation.

Briefly, therefore, the invention is directed to a method for the metallization of a non-conducting substrate comprising the process steps of contacting the substrate with a metal-containing activator solution; contacting the substrate that has been contacted with the activator solution with a metal salt solution comprising at least one metal that can be reduced by the metal of the activator solution, a complexing agent, and at least one metal salt having a metal of the group consisting of lithium, sodium, calcium, rubidium, and cesium in the form of a salt selected from the group consisting of fluorides, chlorides, iodides, bromides, nitrates, sulphates, and mixtures thereof; and subsequently plating the treated substrate with a metal.

In another aspect the invention is directed to a metal-salt solution for treatment of a non-conductive substrate having been treated with a metal colloid for activation, the metal-salt solution comprising a metal that can be reduced by the metal of the metal colloid, a complexing agent, and a metal salt having a metal of the group consisting of lithium, sodium, calcium, rubidium, and cesium in the form of a salt selected from the group consisting of fluorides, chlorides, iodides, bromides, nitrates, sulphates, and mixtures thereof.

Other objects and features of the invention will be in part apparent and in part pointed out herein.

### DETAILED DESCRIPTION OF THE PREFERRED EMBODIMENT(S)

The invention involves a method for the metallization of a non-conducting substrate comprising at least the process steps of contacting the substrate with a metal-containing activator solution and contacting the substrate that has been contacted with the activator solution with a metal salt solution comprising at least one metal that can be reduced by a metal of the activator solution, a complexing agent, and at least one metal of the group consisting of lithium, sodium, calcium, rubidium and cesium. This metal is provided in the form of a salt of the group consisting of fluorides, chlorides, iodides, bromides, nitrates, sulphates, or mixtures of these ones. Thereafter the substrate is subjected to current-free plating or electroplating coating of the treated substrate with a metal. Advantageously, the non-conducting substrates are pre-treated before the treatment with the metal containing activator solution. Such a pre-treatment can for example include a pickling step.

The metal containing activator solution advantageously consists of a solution of a metal-metal colloid having a first core metal and a second colloid metal that colloidally surrounds the core. The core metal advantageously is at least one metal of the group consisting of silver, gold, platinum, or palladium. The colloid metal advantageously is at least on metal of the group consisting of iron, tin, lead, cobalt or germanium.

Other activator solutions known from the state of the art can also be used in the method according to the invention.

After the treatment with the activator solution follows the contacting of the treated substrate with a metal salt solution comprising a) at least one metal that can be reduced by a metal of the activator solution, b) a complexing agent, and c) at least one metal of the group consisting of lithium, sodium, calcium, rubidium, and cesium. As metal that can be reduced by the colloid metal, each metal can be used that has a correspondingly higher standard electrode potential and can thus be reduced by the colloid metal. In particular appropriate are copper, silver, gold, nickel, palladium, platinum, bismuth or mixtures thereof. One such example is copper provided as copper sulphate. Advantageously, the colloid metal of the metal-metal colloid acts as reducing metal of the metal containing activator solution.

As complexing agent, advantageously a complexing agent is used in a quantity which is sufficient for preventing a precipitation of slightly soluble salts of the metals that can be reduced by the colloid metals. Appropriate complexing agents are for example monoethanolamine, EDTA, tartaric acid, lactic acid, citric acid, oxalic acid, salicylic acid, the salts or derivates thereof as well as mixtures thereof. The metal salt solution preferably contains between about 0.25 and about 1.25 moles/liter of the complexing agent.

The least one metal of the group consisting of lithium, sodium, calcium, rubidium, and cesium is provided in the form of a salt of the group consisting of fluorides, chlorides, iodides, bromides, nitrates, sulphates, or mixtures of these ones. The metal salt solution preferably contains between about 0.25 and about 1.25 moles/liter of this metal salt.

The metal salt solution advantageously presents an alkaline pH value comprised between about pH 10 and pH 14, preferably between about pH 11.5 and about pH 13.5, and most preferably between about pH 12.5 and about pH 13.5. For setting the pH value, corresponding hydroxides, other alkalinization agents and/or buffer substances can be added to the metal salt solution.

The contacting of the substrate that has been treated with the activator solution is advantageously carried out at a temperature comprised between about 20 and about 90° C., preferably between about 30 and about 80° C. and most preferably between about 40 and 75° C.

The treatment of the substrate with the metal salt solution according to the invention leads to the current-free deposition of conductive structures on the substrate surface. Hereby, a subsequent current-free or also electroplating coating of the treated substrate with a metal, such as for example the copper plating or nickel plating, is possible.

Besides the method according to the invention, the invention also relates to a metal salt solution that can be used according to the method for the current-free deposition of metals in the above described manner.

The formation of slightly soluble salts of the metal ions present in the process is at least partially prevented by the method according to the invention as well as the metal salt solution according to the invention. Hereby, clearly longer running times and clearly shorter idle times due to maintenance, in particular removal of incrustations of the installations, are possible.

The following examples show embodiments of the invented method, but the invention is not limited to them.

### EXAMPLE 1

An ABS-work is contacted and roughened in a sulphochromic bath. Subsequently the work is washed and conditioned in a colloidal activator solution, consisting 200 mg/l palladium, 30 g/l tin (II) chloride and 300 ml/l concentrated hydrochloric acid. After this the work is washed for the second time and is subsequently submerged in a metal salt solution, which is described in the following, so that a thin conducting film is produced on the non-conducting plastic surface:
1.0 mol/l sodium hydroxide (pH adjustment)
0.5 mol/l lithium chloride
0.4 mol/l potassium sodium tartrate
0.015 mol/l copper sulphate

Again the work is washed and subsequently metallized in an acid polished copper electrolyte by applying a voltage. Through this procedure the ABS-work gets an operational and decorative metallized coat substantially without any defect.

### EXAMPLE 2

An ABS-workpiece is contacted and roughened in a sulphochromic bath. Subsequently the work is washed and conditioned in a colloidal activator solution, consisting 200 mg/l palladium, 30 g/l tin (II) chloride and 300 ml/l concentrated hydrochloric acid. After this the workpiece is washed for the second time and is subsequently submerged in a metal salt solution, which is described in the following, so that a thin conducting film is produced on the non-conducting plastic surface:
0.5 mol/l sodium chloride
0.5 mol/l lithium hydroxide (pH adjustment)
0.5 mol/l calcium bromide
0.4 mol/l potassium sodium tartrate
0.015 mol/l copper sulphate

Again the workpiece is washed and subsequently metallized in an acid polished copper electrolyte by applying a voltage. Through this procedure the ABS-work gets a operational and decorative metallized coat without any objection.

The problems of precipitation known through the state of the art are avoided or clearly reduced by the invented method. Slight incrustation on parts of the unit, like for example heating elements, occur by employment of the invented method only after months. Dead time though has come to a minimum, because the removal of incrustation in regular intervals is not necessary any more.

In view of the above, it may be seen that the several objects of the invention are achieved and other advantageous results attained.

When introducing elements of the present invention or the preferred embodiment(s) thereof, the articles “a”, “an”, “the” and “said” are intended to mean that there are one or more of the elements, notwithstanding that the term “at least one” and the like are used herein. For example, that the foregoing description and following claims refer to “a” cation means that there are one or more such cations. The terms “comprising,” “including,” and “having” are intended to be inclusive and mean that there may be additional elements other than the listed elements.

As various changes could be made in the above without departing from the scope of the invention, it is intended that all matter contained in the above description and shown in the accompanying drawings shall be interpreted as illustrative and not in a limiting sense. The scope of invention is defined by the appended claims and modifications to the embodiments above may be made that do not depart from the scope of the invention.

What is claimed is:

1. A method for the metallization of a non-conducting substrate comprising the process steps of:
contacting the substrate with a metal-containing activator solution;
contacting the substrate that has been contacted with the activator solution with a metal salt solution comprising at least one metal that can be reduced by the metal of the activator solution, a complexing agent, and at least one metal salt having a metal of the group consisting of lithium, sodium, calcium, rubidium, and cesium in the form of a salt selected from the group consisting of fluorides, chlorides, iodides, bromides, nitrates, sulphates, and mixtures thereof; and
subsequently plating the treated substrate with a metal.

2. The method of claim 1 wherein the metal-containing activator solution comprises a metal/metal colloid with a first metal as core and a second metal encompassing the first metal, wherein the first metal is selected from the group consisting of silver, gold, platinum, and palladium, and the second metal is selected from the group consisting of iron, tin, lead, cobalt, and germanium.

3. The method of claim 1 wherein the metal salt solution comprises a complexing agent selected from the group consisting of monoethanolamine, EDTA, tartaric acid, lactic acid, citric acid, oxalic acid, salicylic acid, the salts or derivates as well as mixtures thereof.

4. The method of claim 1 wherein the metal salt solution has an alkaline pH between about 10 and about 14.

5. The method of claim 1 wherein the metal salt solution has an alkaline pH between about 11.5 and about 13.5.

6. The method of claim 1 wherein the metal salt solution has an alkaline pH between about 12.5 and about 13.5.

7. The method of claim 1 wherein the contacting with the metal salt solution is performed at a temperature between about 20° C. and about 90° C.

8. The method of claim 1 wherein the contacting with the metal salt solution is performed at a temperature between about 30° C. and about 80° C.

9. The method of claim 1 wherein the contacting with the metal salt solution is performed at a temperature between about 40° C. and about 75° C.

10. The method of claim 1 wherein the metal salt solution comprises between about 0.25 and about 1.5 moles/liter of the metal salt.

11. The method of claim 1 wherein the metal that can be reduced by the metal of the metal colloid is selected from the group consisting of copper, silver, gold, nickel, palladium, platinum, bismuth, and mixtures thereof.

12. The method of claim 1 wherein the least one metal that can be reduced by the metal of the activator solution is copper provided as copper sulphate.

13. A method for the metallization of a non-conducting substrate comprising the process steps of:
contacting the substrate with a metal-containing activator solution;
contacting the substrate that has been contacted with the activator solution with a metal salt solution comprising at least one metal that can be reduced by the metal of the activator solution, a complexing agent, and between about 0.25 and about 1.5 moles/liter of a metal salt having a metal of the group consisting of lithium, sodium, calcium, rubidium, and cesium in the form of a salt selected from the group consisting of fluorides, chlorides, iodides, bromides, nitrates, sulphates, and mixtures thereof; and
subsequently plating the treated substrate with a metal coating.

14. The method of claim 13 wherein:
the contacting the substrate with the metal-activator solution comprises contacting the substrate with a colloid containing a noble metal.

15. The method of claim 13 wherein the metal salt solution comprises approximately:
1.0 mol/l sodium hydroxide
0.5 mol/l lithium chloride
0.4 mol/l calcium sodium tartrate
0.015 mol/l copper sulphate.

16. The method of claim 13 wherein the metal salt solution comprises approximately:
0.5 mol/l sodium chloride
0.5 mol/l lithium hydroxide
0.5 mol/l calcium bromide
0.4 mol/l calcium sodium tartrate
0.015 mol/l copper sulphate.

17. A metal-salt solution for treatment of a non-conductive substrate having been treated with a metal colloid for activation, the metal-salt solution comprising:
a metal that can be reduced by the metal of the metal colloid;
a complexing agent; and
a metal salt having a metal of the group consisting of lithium, sodium, calcium, rubidium, and cesium in the form of a salt selected from the group consisting of fluorides, chlorides, iodides, bromides, nitrates, sulphates, and mixtures thereof.

18. The metal-salt solution of claim 17 wherein the metal salt is present in a concentration between about 0.25 and 1.5 moles/liter.

19. The metal-salt solution of claim 17 wherein the metal that can be reduced by the metal of the metal colloid is selected from the group consisting of copper, silver, gold, nickel, palladium, platinum, bismuth, and mixtures thereof.
